(19) United States
(12) Patent Application Publication
(10) Pub. No.: US 2019/0286468 A1
(43) Pub. Date: Sep. 19, 2019

(54) EFFICIENT CONTROL OF CONTAINERS IN A PARALLEL DISTRIBUTED SYSTEM

(71) Applicant: FUJITSU LIMITED, Kawasaki-shi (JP)

(72) Inventors: YUICHI MATSUDA, Yokohama (JP); Nobuyuki KUROMATSU, Kawasaki (JP)

(73) Assignee: FUJITSU LIMITED, Kawasaki-shi (JP)

(21) Appl. No.: 16/289,731

(22) Filed: Mar. 1, 2019

(30) Foreign Application Priority Data
Mar. 15, 2018 (JP) 2018-047440

(51) Int. Cl. G06F 9/455

(52) U.S. Cl. CPC G06F 9/45558; G06F 2009/45591; G06F 2009/45595

(57) ABSTRACT

An apparatus serving as each of multiple slave nodes monitors a communication response condition of containers constituting the multiple slave nodes included in an information processing system in which a container constituting a master node and the containers constituting the multiple slave nodes cooperate with one another and perform distributed processing. When an anomaly is detected in the communication response condition of a given container of the containers included in the multiple slave nodes, the apparatus estimates an operating condition of the given host machine in accordance with information indicating a given host machine on which the given container is running, and sets a time-out time that is calculated based on an amount of data for the distributed processing and that is referred to when it is determined whether to cause the given container to run on a host machine different from the given host machine.

### CROSS-REFERENCE TO RELATED APPLICATION

This application is based upon and claims the benefit of priority of the prior Japanese Patent Application No. 2018-47440, filed on Mar. 15, 2018, the entire contents of which are incorporated herein by reference.

### FIELD

The embodiment discussed herein is related to efficient control of containers in a parallel distributed system.

### BACKGROUND

For example, a service provider (hereinafter also simply referred to as a provider) that provides users with a service develops and runs a business system (hereinafter also referred to as an information processing system) for providing the service. Specifically, when developing the business system, the provider utilizes, for example, a container-based virtualization technology (for example, Docker) for efficiently providing a service. The container-based virtualization technology is a technology for creating on a physical machine (hereinafter also referred to as a host machine) containers that are the isolated environments from the host machine.

Unlike a hypervisor virtualization technology, such a container-based virtualization technology creates containers without creating a guest operating system (OS). As a result, compared with the hypervisor virtualization technology, the container-based virtualization technology has an advantage of less overhead for creating containers (see, for example, Japanese Laid-open Patent Publication Nos. 2006-031096, 06-012294, and 11-328130).

### SUMMARY

According to an aspect of the embodiments, an apparatus serving as each of multiple slave nodes monitors a communication response condition of containers constituting the multiple slave nodes included in an information processing system in which a container constituting a master node and the containers constituting the multiple slave nodes cooperate with one another and perform distributed processing. When an anomaly is detected in the communication response condition of a given container of the containers included in the multiple slave nodes, the apparatus estimates an operating condition of the given host machine in accordance with information indicating a given host machine on which the given container is running, and sets a time-out time that is calculated based on an amount of data for the distributed processing and that is referred to when it is determined whether to cause the given container to run on a host machine different from the given host machine.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an overall configuration of an information processing system 10;

FIG. 2 illustrates functions of containers that run on a host machine;

FIG. 3 illustrates the functions of the containers that run on the host machine;

FIG. 4 illustrates the functions of the containers that run on the host machine;

FIG. 5 illustrates the functions of the containers that run on the host machine;

FIG. 6 illustrates a hardware configuration of the host machine;

FIG. 7 is a block diagram illustrating functions of a master node;

FIG. 8 is a flowchart illustrating an outline of control processing according to a first embodiment;

FIG. 9 illustrates the outline of the control processing according to the first embodiment;

FIG. 10 illustrates the outline of the control processing according to the first embodiment;

FIG. 11 illustrates the outline of the control processing according to the first embodiment;

FIG. 12 illustrates the outline of the control processing according to the first embodiment;

FIG. 13 is a flowchart illustrating details of the control processing according to the first embodiment;

FIG. 14 is a flowchart illustrating details of the control processing according to the first embodiment;

FIG. 15 is a flowchart illustrating details of the control processing according to the first embodiment;

FIG. 16 is a flowchart illustrating details of the control processing according to the first embodiment;

FIG. 17 is a flowchart illustrating details of the control processing according to the first embodiment; and

FIG. 18 illustrates a specific example of corresponding information.

### DESCRIPTION OF EMBODIMENTS

When running Hadoop as processes in the containers, a JobTracker and a NameNode, which are functions included in a master node, and a TaskTracker and a DataNode, which are functions included in a slave node, each run as a process in a container. The JobTracker that runs as a process in a container, for example, performs distributed processing of data targeted for processing (hereinafter also referred to as task data) in cooperation with the TaskTrackers that run as processes in multiple containers.

When a TaskTracker in a container is restarted during the distributed processing of task data, the JobTracker in a container redistributes the task data targeted for processing among the slave nodes where the TaskTrackers exist and restarts a job from the beginning.

When a time-out occurs while the JobTracker waits for a response from a slave node, for example, the JobTracker does not perform the distributed processing of task data on the TaskTracker that is included in the slave node; in other words, in this case, the JobTracker determines that the TaskTracker is not able to be used (hereinafter the state in which the TaskTracker is not able to be used is also referred to as being blacklisted). As a result, the JobTracker in this case redistributes the task data targeted for processing among TaskTrackers other than the TaskTracker relating to the time-out that has occurred and restarts the job from the beginning.

The master node including the above-described JobTracker is, for example, in cooperation with other functions, able to determine whether there are notification responses from the TaskTracker and the DataNode (hereinafter also referred to as the TaskTracker and the like) that are running in containers of slave nodes. The master node, however, is not able to monitor operating conditions of the host machine on which the TaskTracker and the like are running; in other words, for example, when there is no response from the TaskTracker and the like that are running in containers of slave nodes, the master node is not able to determine whether anomalies occur in both the TaskTracker and the like and the host machine or only in the TaskTracker and the like.

As a result, for example, when a time-out occurs due to prolonged redistribution of task data in response to restarting the TaskTracker (when no anomaly exists in the host machine), the JobTracker may stop the redistribution of the task data that is being performed and start the redistribution of the task data from the beginning, where the redistribution of task data is performed in response to the occurrence of the time-out. Therefore, when no anomaly exists in the host machine, restarting the TaskTracker may take excessive time.

It is preferable to enable, by efficiently performing the restart operation, a reduction in time for restarting a TaskTracker that runs as a process in a container.

Configuration of Information Processing System

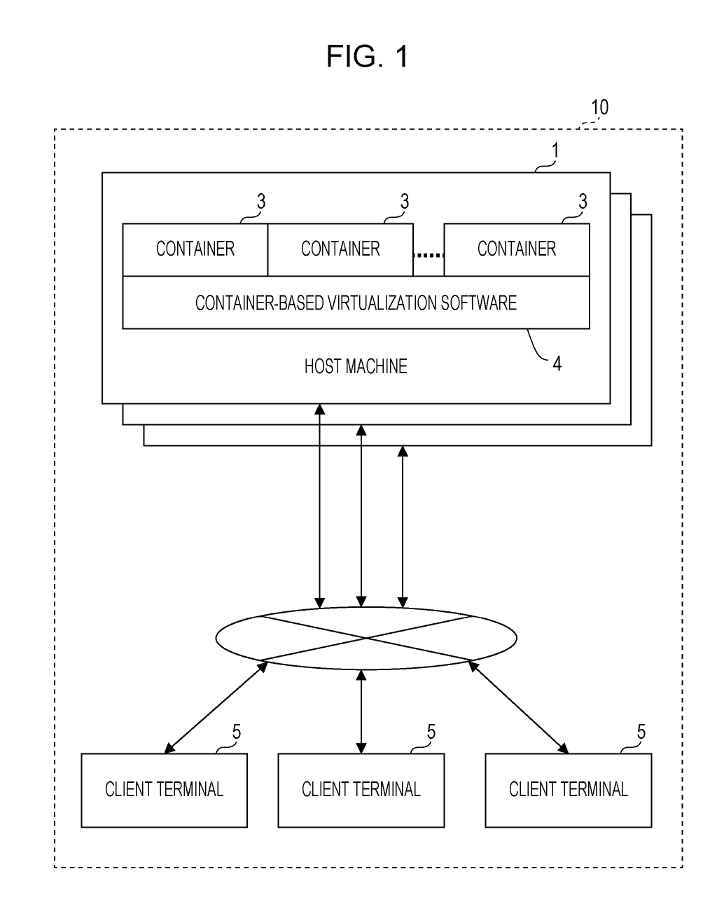

FIG. 1 illustrates an overall configuration of an information processing system 10. The information processing system 10 illustrated in FIG. 1 is, for example, a business system for providing users with a service. In the information processing system 10 in FIG. 1, a host machine 1 is installed in a data center (not illustrated). Client terminals 5 are able to access the data center via a network such as the Internet or an intranet.

The host machine 1 is composed of, for example, multiple physical machines. Each physical machine has a central computing unit (CPU), a memory (for example, a dynamic random access memory (DRAM)), and a large-capacity storage device, such as a hard disk drive (HDD). The physical resources of the host machine 1 are allocated for multiple containers 3 in which multiple kinds of processing are performed to provide users with a service.

Container-based virtualization software 4 is infrastructure software that creates the containers 3 by allocating CPUs, memory, hard disk drives of the host machine 1, and the network for the containers 3. The container-based virtualization software 4 runs on, for example, the host machine 1

Functions of Virtual Machines That Run on Host Machine

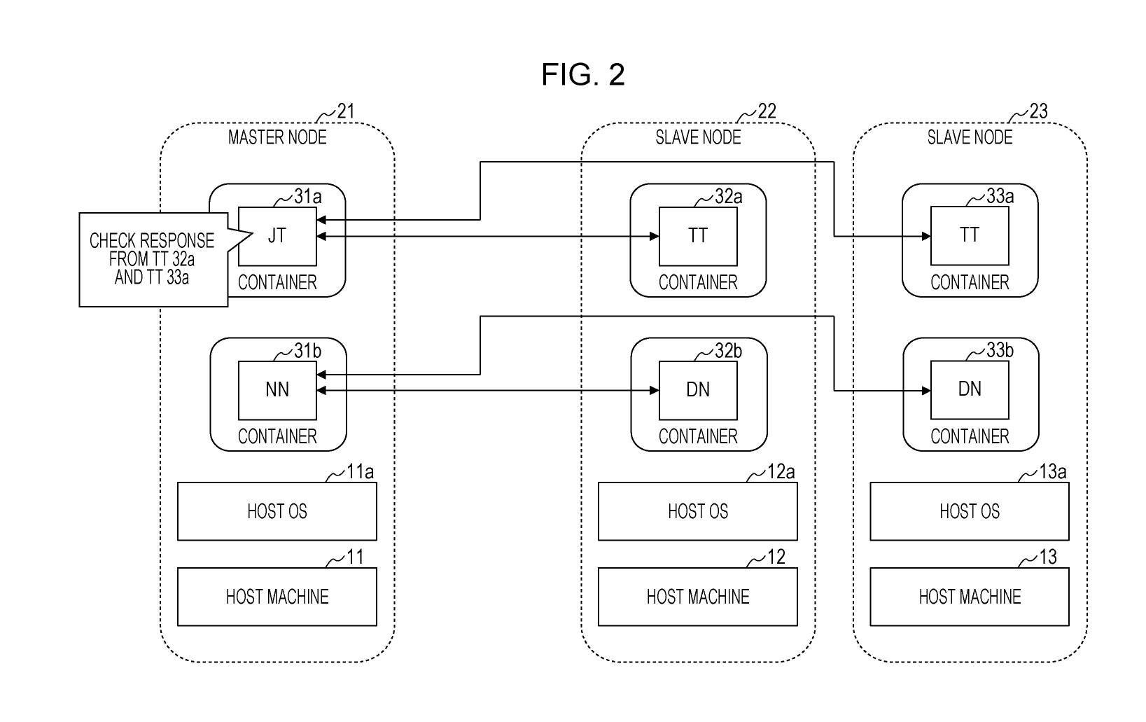

Next, functions of the containers 3 that run on the host machine 1 are described. FIGS. 2 to 4 illustrate the functions of the containers 3 that run on the host machine 1. In the following description, it is assumed that the host machine 1 illustrated in FIG. 1 includes host machines 11, 12, and 13 on which host OSs 11a, 12a, and 13a respectively run. It is also assumed in the following description that only one master node or one slave node is able to run on each of the host machine 1 host machines.

A master node 21 runs on the host machine 11 illustrated in FIG. 2. The master node 21 contains a JobTracker container 31a (hereinafter also referred to as the JT 31a) that is the container 3 in which a JobTracker runs as a process and a NameNode container 31b (hereinafter also referred to as the NN 31b) that is the container 3 in which a NameNode runs as a process.

A slave node 22 runs on the host machine 12 illustrated in FIG. 2. The slave node 22 contains a TaskTracker container 32a (hereinafter also referred to as the TT 32a) that is the container 3 in which a TaskTracker runs as a process and a DataNode container 32b (hereinafter also referred to as the DN 32b) that is the container 3 in which a DataNode runs as a process.

A slave node 23 runs on the host machine 13 illustrated in FIG. 2. The slave node 23 contains a TaskTracker container 33a (hereinafter also referred to as the TT 33a) and a DataNode container 33b (hereinafter also referred to as the DN 33b).

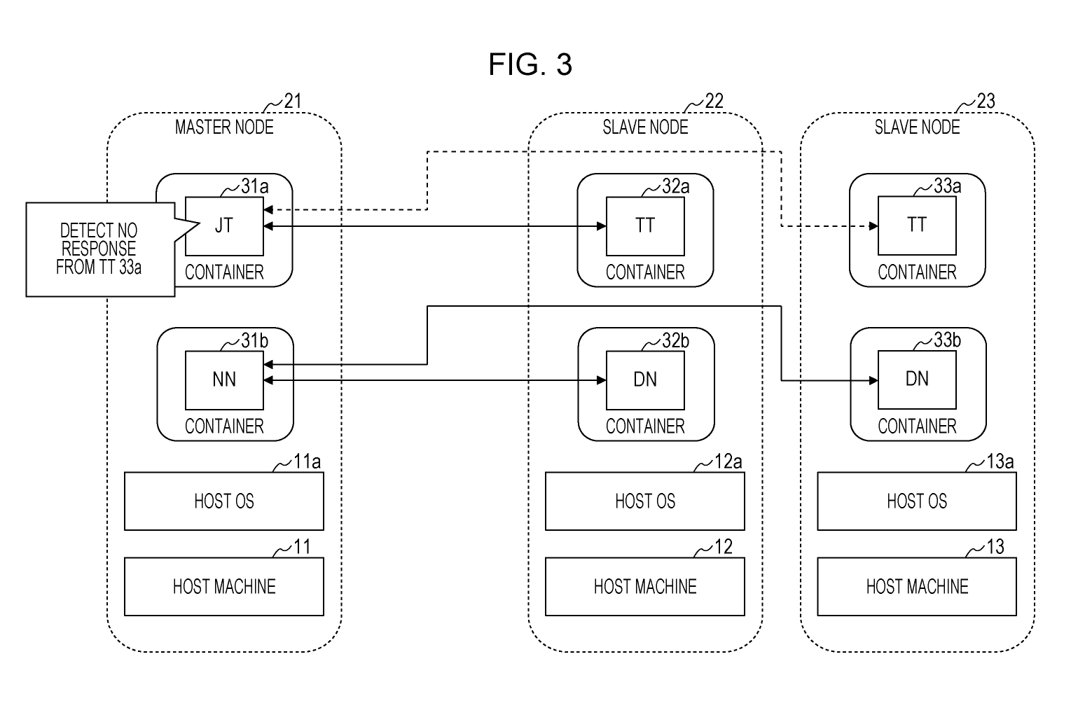

The master node 21 (a communication function included in the master node 21), for example, determines whether a communication response is sent periodically from the TT 32a and the TT 33a as illustrated in FIG. 2. As a result, for example, if interruption of the communication response from the TT 33a is detected as illustrated in FIG. 3, the master node 21 determines that there is a possibility in which an anomaly has occurred in the TT 33a.

The master node 21 is able to determine whether notification responses are sent from other containers 3 (the TT 32a, the DN 32b, the TT 33a, and the DN 33b). The master node 21, however, is not able to monitor the operating conditions of the host machines 12 and 13 on which the other containers 3 are running; in other words, for example, when there is no response from the other containers 3, the master node 21 is not able to determine whether anomalies occur in both the containers 3 and the host machines 1 or only in the containers 3.

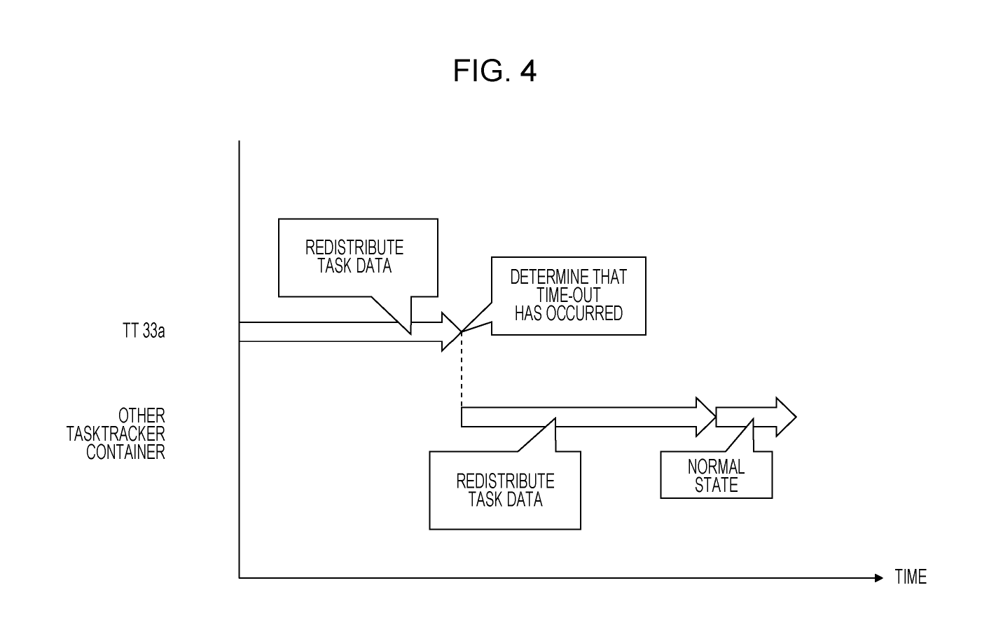

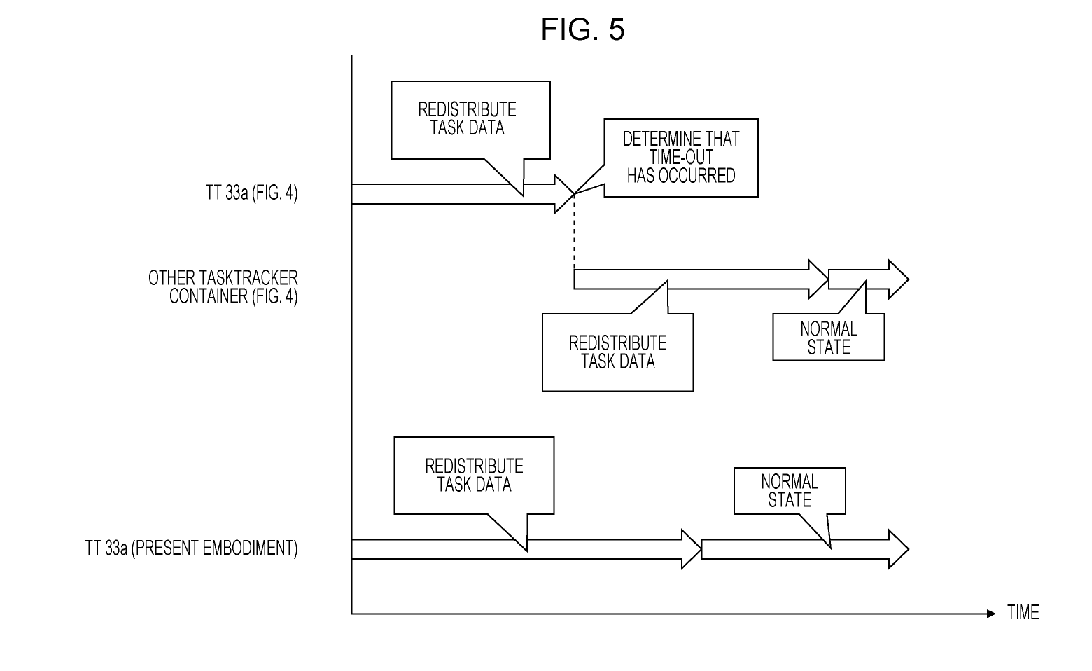

As a result, for example, when a time-out occurs due to prolonged redistribution of task data in response to restarting the TT 33a (when no anomaly exists in the host machine 13), the JT 31a may stop the redistribution of the task data that is being performed and start the redistribution of the task data from the beginning, where the redistribution of task data is performed in response to the occurrence of the time-out as illustrated in FIG. 4. Therefore, when no anomaly exists in the host machine 13, the JT 31a may take excessive time to restart the TT 33a.

The master node 21 according to the embodiment monitors the communication response condition of, for example, the containers 32a and 33a that respectively constitute the multiple slave nodes 22 and 23. When the master node 21 detects an anomaly in the communication response condition of, for example, any one container (hereinafter also referred to as the given container) of the containers 3 included in the multiple slave nodes 22 and 23, in accordance with information (hereinafter also referred to as the corresponding information) that indicates the host machine 1 (hereinafter also referred to as the given host machine) on which the given previously deployed container is running, the master node 21 estimates the operating condition of the given host machine.

Subsequently, in accordance with the estimation result, the master node 21 sets a time-out time that is calculated based on the amount of data for distributed processing and that is referred to when it is determined whether to cause the given container to run on a host machine 1 different from the given host machine.

For example, when the master node 21 detects that the communication response from the TT 33a is interrupted, by referring to the corresponding information, the master node 21 determines whether the host machine 13 on which the TT 33a is running is stopped. Specifically, the master node 21 determines whether an anomaly has occurred in both the containers 3 (the TT 33a and the DN 33b) running on the host machine 13 or in only the containers 3 running on the host machine 13.

Subsequently, for example, when the master node 21 determines that an anomaly has occurred in only the containers 3 running on the host machine 13 (when the master node 21 determines that no anomaly exists in the host machine 13), the master node 21 uses a time calculated in advance in accordance with the amount of task data targeted for processing as the time-out time that is referred to when it is determined whether a time-out has occurred.

As a result, when the master node 21 determines that no anomaly exists in the host machine 13, it is possible to complete restarting the TT 33a before the time-out time has elapsed. Therefore, when no anomaly has occurred in the host machine 13, the master node 21 is able to avoid interruption of redistributing task data due to restarting the TT 33a. As illustrated in FIG. 5, the master node 21 is able to reduce the time for restarting the TT 33a compared with the case illustrated in FIG. 4.

Hardware configuration of information processing system

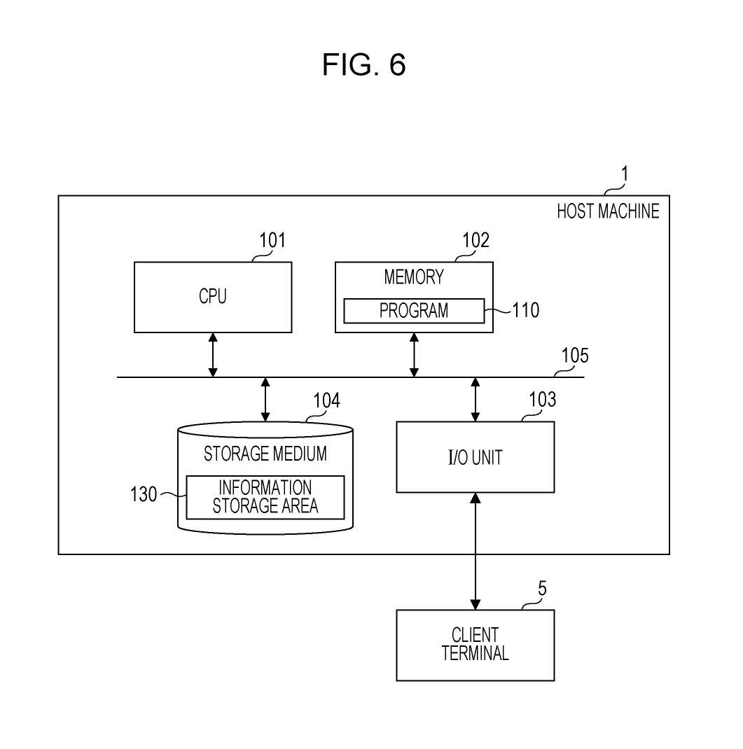

Next, a hardware configuration of the information processing system 10 is described. FIG. 6 illustrates a hardware configuration of the host machine 1.

The host machine 1 includes a CPU 101 as a processor, a memory 102, an external interface (hereinafter also referred to as the input/output (I/O) unit) 103, and a storage medium 104. These units are coupled via a bus 105.

The storage medium 104 includes, for example, a program storage area (not illustrated) for storing a program 110 for performing processing (hereinafter also referred to as control processing) in which a JobTracker container manages TaskTracker containers. The storage medium 104 also includes, for example, an information storage area 130 (hereinafter also referred to as the memory unit 130) to store information used when the control processing is performed.

The CPU 101 retrieves the program 110 from the storage medium 104 and loads the program 110 into the memory 102 to execute the program 110, and the CPU 101 performs the control processing in cooperation with the program 110. The external interface 103 communicates with, for example, the client terminals 5.

Functions of master node and information referred to by master node

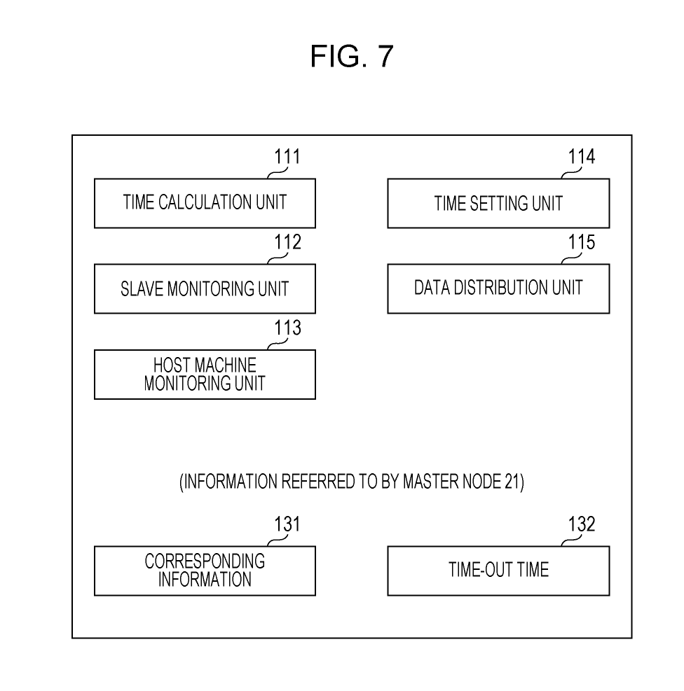

Next, functions of the master node 21 are described. FIG. 7 is a block diagram illustrating functions of the master node 21.

As illustrated in FIG. 7, the CPU 101 of the host machine 1, in cooperation with the program 110, implements functions of the master node 21 such as functions performed by a time calculation unit 111, a slave monitoring unit 112, a host machine monitoring unit 113, a time setting unit 114, and a data distribution unit 115. The master node 21 refers to the corresponding information 131 and a time-out time 132 that are stored in the information storage area 130.

The time calculation unit 111 calculates, based on the amount of task data targeted for distributed processing, the time-out time 132 that is referred to when it is determined whether to blacklist the TT 32a or the TT 33a. Specifically, the time calculation unit 111, for example, calculates in accordance with the amount of new task data the time-out time 132 whenever the amount of new task data targeted for distributed processing is obtained.

The slave monitoring unit 112 monitors the communication response condition of the containers 32a, 32b, 33a, and 33b that constitute the multiple slave nodes 22 and 23. Specifically, the slave monitoring unit 112, for example, determines whether the communication response from the TTs 32a, 32b, 33a, and 33b are sent periodically.

When the slave monitoring unit 112 detects an anomaly in the communication response condition of the given container (for example, either the containers 32a or 33a), the host machine monitoring unit 113 refers to the corresponding information 131 stored in the information storage area 130 and estimates the operating condition of the given host machine on which the given container is running. The corresponding information 131 is information in which a host machine and a group of containers (a TaskTracker container and a DataNode container) that constitute a slave node are associated with one another. A specific example of the corresponding information 131 will be described later.

When the host machine monitoring unit 113 determines that an anomaly has occurred in the given host machine, the time setting unit 114 causes the master node 21 to refer to the time-out time 132 calculated by the time calculation unit 111. Specifically, the time setting unit 114 sets the time-out time 132 calculated by the time calculation unit 111 in an area (for example, a predetermined area of the memory 102) that is referred to by the master node 21 when determining whether a time-out has occurred.

The data distribution unit 115, which performs a function of the JT 31a, distributes task data targeted for processing among the TT 32a and the TT 33a

### Outline of First Embodiment

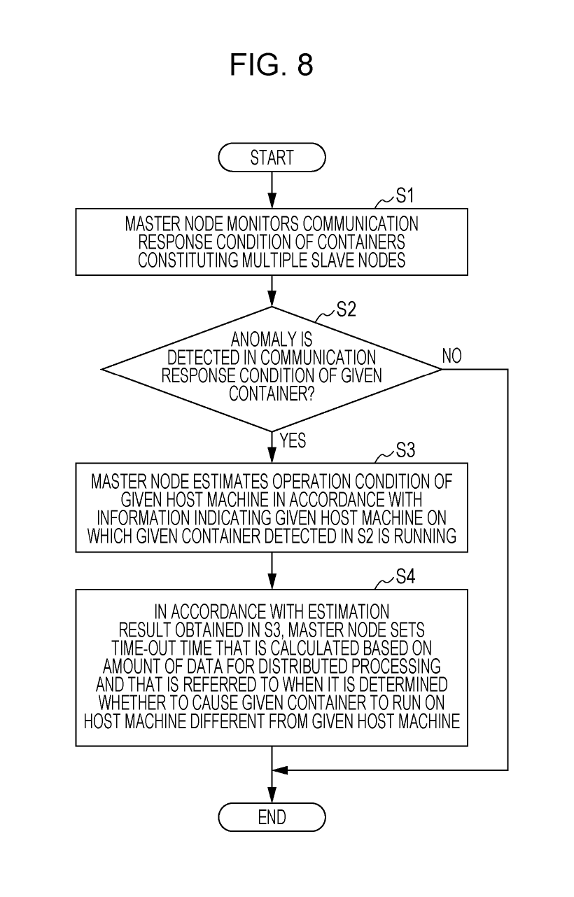

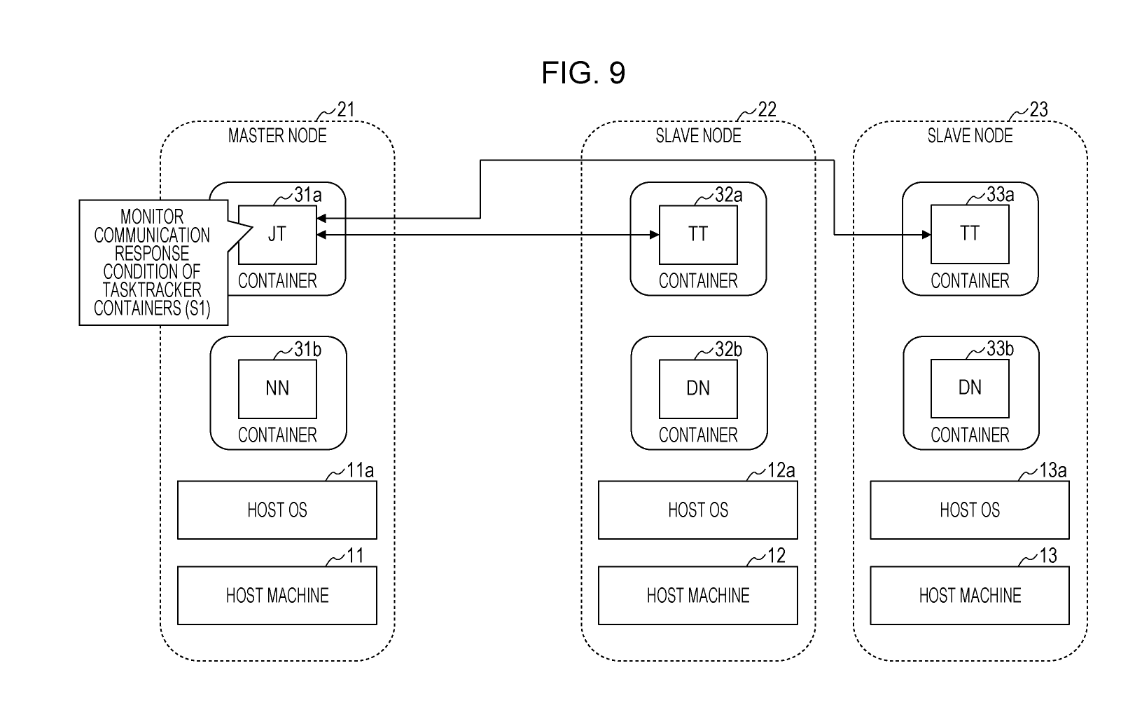

Next, an outline of the first embodiment is described. FIG. 8 is a flowchart illustrating an outline of the control processing according to the first embodiment. FIGS. 9 to 12 also illustrate the outline of the control processing according to the first embodiment. The outline of the control processing according to the first embodiment illustrated in FIG. 8 is described with reference to FIGS. 9 to 12.

The master node 21 monitors the communication response condition of the containers 32a and 33a that respectively constitute the multiple slave nodes 22 and 23 (S1). Specifically, the master node 21, for example, determines whether communication responses are sent periodically from the TT 32a and the TT 33a as illustrated in FIG. 9.

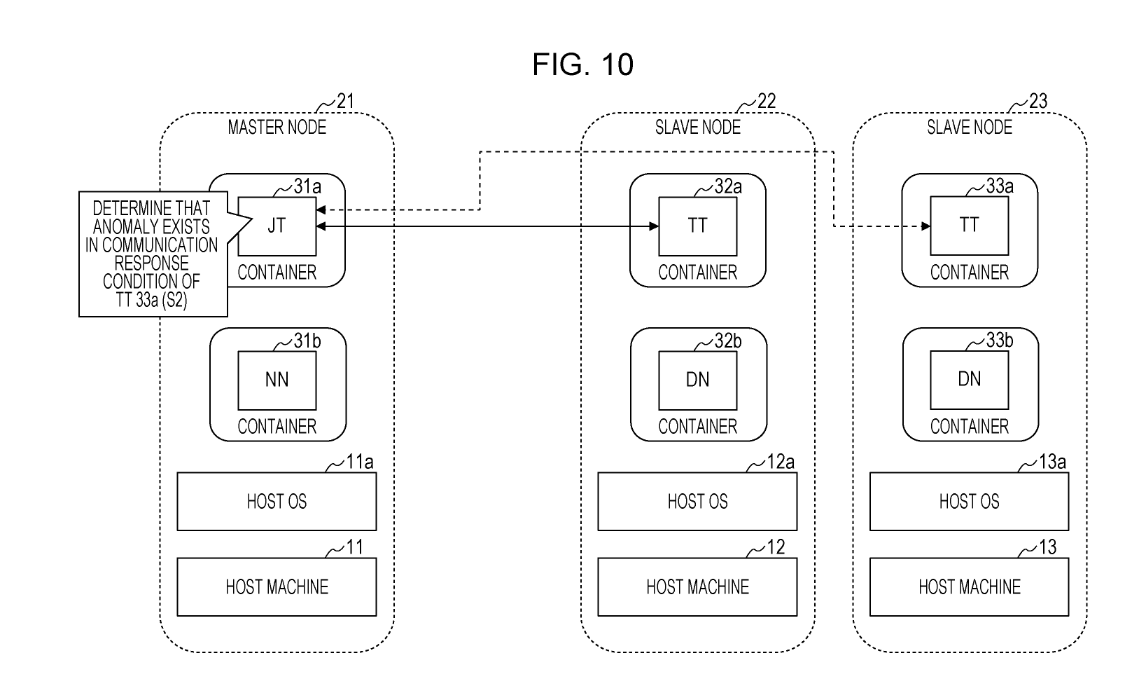

The master node 21 determines whether an anomaly exists in the communication response condition of any container (the given container) of the containers 32a and 33a that respectively constitute the multiple slave nodes 22 and 23 as illustrated in FIG. 10 (S2).

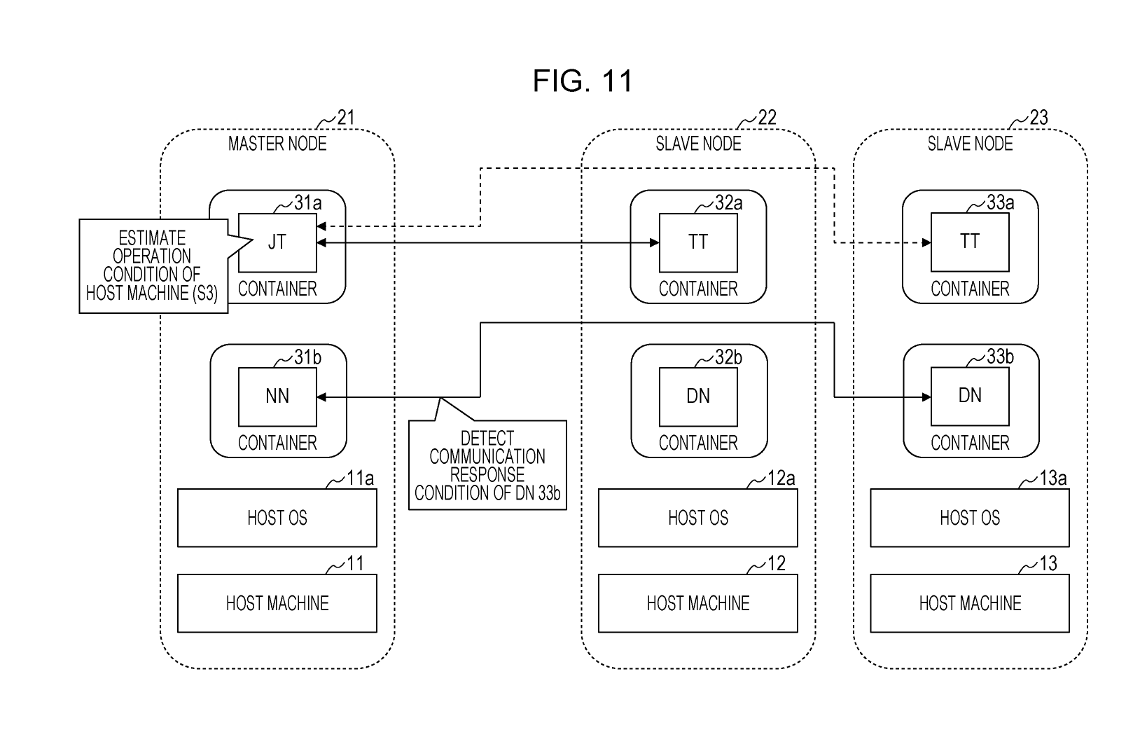

As a result, in a case where an anomaly is detected in the communication response condition of the given container (YES in S2), the master node 21 estimates the operating condition of the given host machine in accordance with information indicating the given host machine on which the given container detected in S2 is running as illustrated in FIG. 11 (S3).

Specifically, for example, when it is detected that the communication response from the TT 33a is interrupted, the master node 21 refers to the corresponding information 131 and identifies the host machine 13 as the host machine 1 on which the TT 33a is running. Subsequently, the master node 21 refers to the corresponding information 131 and identifies the DN 33b (the container 3 other than that of the TT 33a among the containers 3 that are running on the host machine 13) that is running on the identified host machine 13. The master node 21 then determines whether the communication response is sent periodically from the DN 33b. As a result, when it is determined that the communication response is sent periodically from the DN 33b, the master node 21 determines that no anomaly exists in the host machine 13. Conversely, when it is determined that the communication response from the DN 33b is interrupted, the master node 21 determines that an anomaly has occurred in the host machine 13.

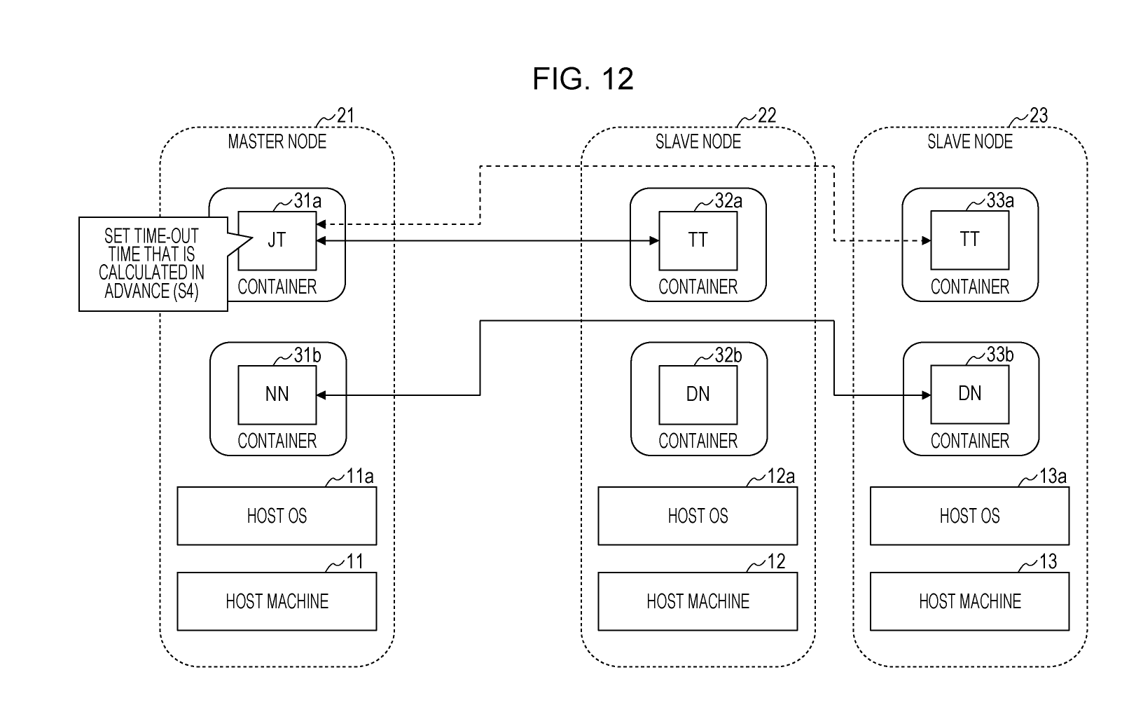

Subsequently, in accordance with the estimation result obtained in the processing in S3, the master node 21 sets the time-out time 132 that is calculated based on the amount of data for distributed processing and that is referred to when it is determined whether to cause the given container to run on a host machine 1 different from the given host machine as illustrated in FIG. 12 (S4). In a case where no anomaly is detected in the communication response condition of the given container (NO in S2), the master node 21 does not perform the processing in S3 and S4.

As a result, when the master node 21 determines that no anomaly exists in the host machine 13, by setting the new time-out time 132, it is possible to complete restarting the TT 33a before the time-out time has elapsed.

### Details of First Embodiment

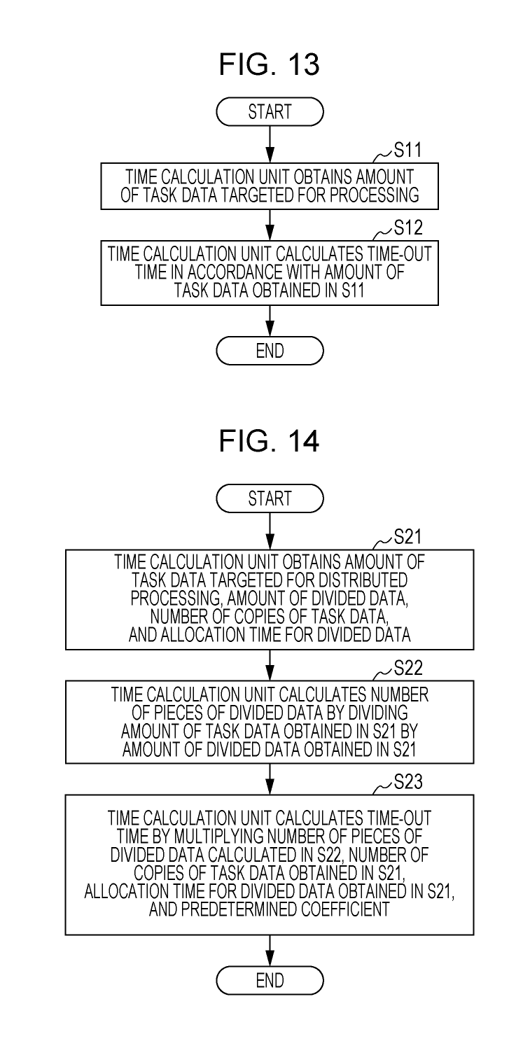

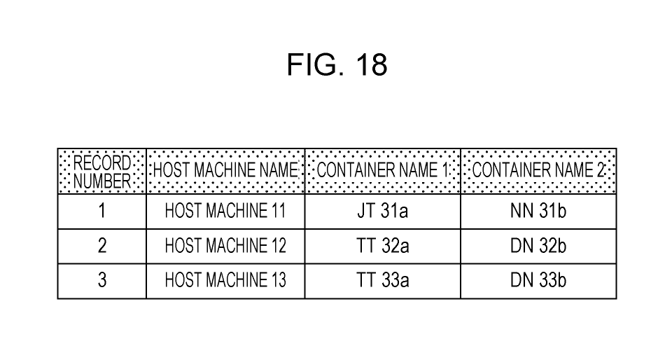

Next, the first embodiment is described in detail. FIGS. 13 to 17 are flowcharts illustrating details of the control processing according to the first embodiment. FIG. 18 also illustrates the details of the control processing according to the first embodiment. Referring to FIG. 18, the details of the control processing illustrated in FIGS. 13 to 17 are described.

Time Calculation Processing

First, time calculation processing preliminary to the control processing is described. The time calculation processing is processing for calculating the time-out time 132 in accordance with the amount of task data targeted for processing. FIG. 13 is a flowchart illustrating the time calculation processing.

The time calculation unit 111 of the master node 21 obtains the amount of task data targeted for processing as illustrated in FIG. 13 (S11). The time calculation unit 111 subsequently calculates the time-out time 132 in accordance with the amount of the task data obtained in the processing in S11 (S12). The details of the processing in S12 are described below.

Details of Processing in S12

FIG. 14 is a flowchart illustrating the details of the processing in S12.

The time calculation unit 111 obtains, for example, the amount of task data M (GB), the task data being targeted for distributed processing, the amount of divided data D (MB), the number of copies of task data R (piece), and an allocation time for divided data W (sec) (S21). The amount of divided data D is the amount of data of one data unit for which the individual TaskTracker container performs processing. A provider, for example, may in advance store in the information storage area 130 information on the amount of task data M, the amount of divided data D, the number of copies of task data R, and the allocation time for divided data W. The time calculation unit 111 may obtain these kinds of information by referring to, for example, the information storage area 130.

Subsequently, the time calculation unit 111 calculates the number of pieces of divided data by, for example, dividing the amount of task data M obtained in the processing in S21 by the amount of divided data D obtained in the processing in S21 (S22). The time calculation unit 111 then calculates the time-out time 132 by, for example, multiplying the number of pieces of divided data calculated in S22, the number of copies of task data R obtained in S21, and the allocation time for divided data W obtained in the processing in S21 (S23).

Accordingly, the time calculation unit 111 calculates the time-out time 132 in the processing in S22 and S23 by using, for example, the following equation (1).

Time-out time 132=(M/D)×R×W (1)

In such a manner, the time calculation unit 111 is able to approximately calculate, for example, a processing time that one TaskTracker container spends performing processing for all pieces of divided data as the new time-out time 132.

The time calculation unit 111 may calculate as the new time-out time 132, for example, a value obtained by multiplying the value calculated by using the equation (1) by a predetermined coefficient (for example, 1.1).

Details of Control Processing

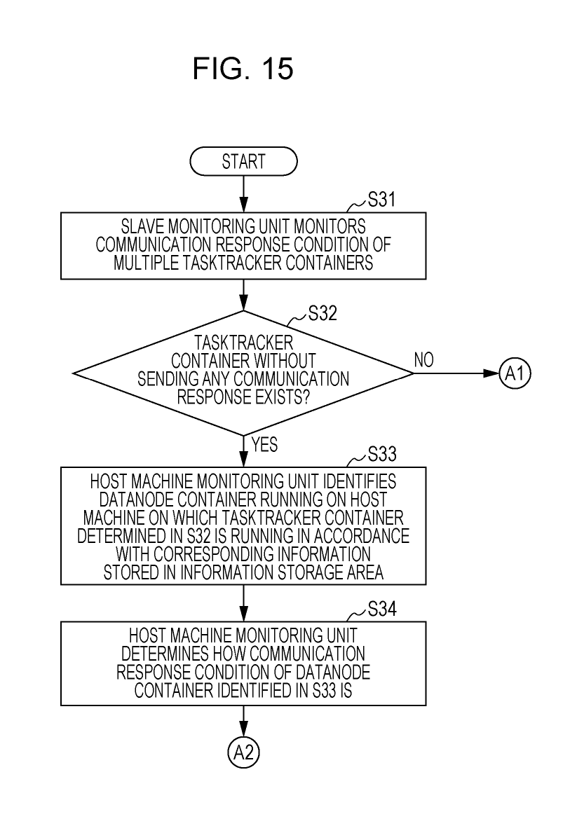

Next, details of the control processing is described. FIGS. 15 to 17 are flowcharts illustrating details of the control processing.

The slave monitoring unit 112 of the master node 21 monitors communication response condition of the TT 32a and the TT33a as illustrated in FIG. 15 (S31). The slave monitoring unit 112 determines whether the TT 32a or the TT 33a is not sending any communication response (S32).

As a result, the host machine monitoring unit 113 of the master node 21 identifies the DataNode container running on the host machine 1 on which the TaskTracker container determined in the processing in S32 is running in accordance with the corresponding information 131 stored in the information storage area 130 (S33). A specific example of the corresponding information 131 is described below.

### SPECIFIC EXAMPLE OF CORRESPONDING INFORMATION

FIG. 18 illustrates a specific example of the corresponding information 131.

The corresponding information 131 illustrated in FIG. 18 includes fields of “record number” for identifying respective items of information contained in the corresponding information 131, “host machine name” for which host machine names are set, and “container name 1” and “container name 2” for which container names are set.

Specifically, in the corresponding information 131 illustrated in FIG. 18, in the record whose “record number” is “1”, “host machine 11” is set as “host machine name”, “JT 31a” is set as “container name 1”, “NN 31b” is set as “container name 2”.

Similarly, in the corresponding information 131 illustrated in FIG. 18, in the record whose “record number” is “2”, “host machine 12” is set as “host machine name”, “TT 32a” is set as “container name 1”, “DN 32b” is set as “container name 2”.

Likewise, in the corresponding information 131 illustrated in FIG. 18, in the record whose “record number” is “3”, “host machine 13” is set as “host machine name”, “TT 33a” is set as “container name 1”, “DN 33b” is set as “container name 2”.

Specifically, for example, when the TT 33a is identified in the processing in the S33 as the TaskTracker container from which no communication response is sent, the host machine monitoring unit 113 refers to the corresponding information 131 described in FIG. 18 and identifies “host machine 13” set as “host machine name” in the record in which “TT 33a” is set as either “container name 1” or “container name 2”. The host machine monitoring unit 113 further refers to the corresponding information 131 described in FIG. 18 and identifies “DN 33b” other than “TT 33a” among items set as “container name 1” and “container name 2” in the record in which “host machine 13” is set as “host machine name”.

Referring back to FIG. 15, the host machine monitoring unit 113 determines how the communication response condition of the DataNode container identified in the processing in S33 is (S34).

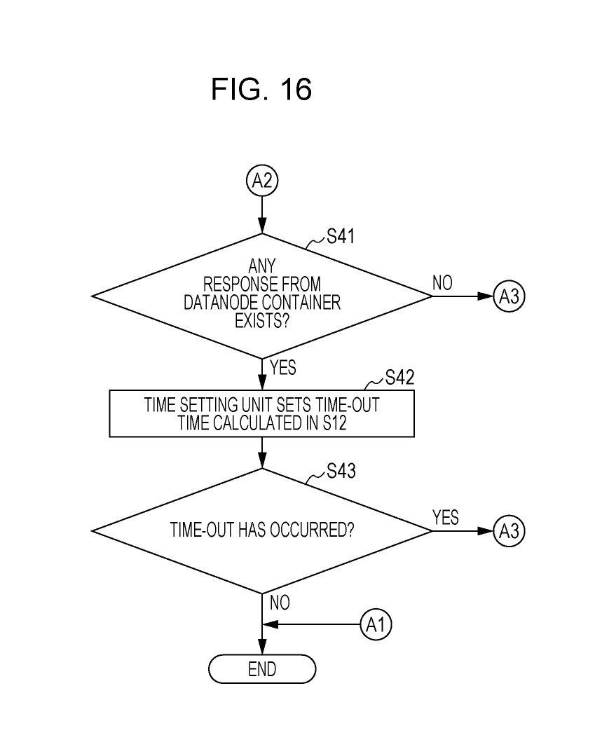

As a result, as illustrated in FIG. 16, in a case where it is determined that any response from the DataNode container exists (YES in S41), the time setting unit 114 of the master node 21 sets the time-out time 132 calculated in the processing in S12 (S42). Specifically, the time setting unit 114 sets the time-out time 132 calculated in the processing in S12 in, for example, an area (for example, a predetermined area of the memory 102) that is referred to by the master node 21 when it is determined whether to blacklist the TT 32a or the TT 33a.

In a case where a time-out has not occurred in the TaskTracker container that is determined to exist in the processing in S32 (NO in S43), the master node 21 ends the control processing.

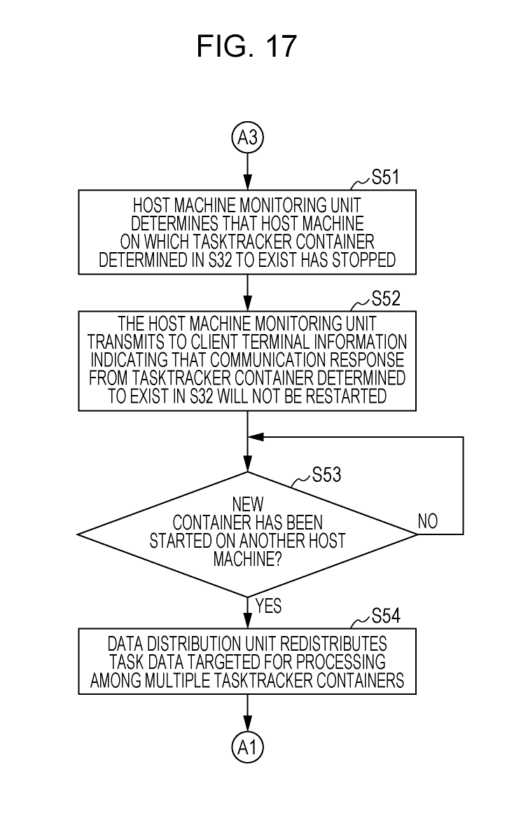

Conversely, in a case where it is determined that no response from the DataNode container exists (NO in S41), the host machine monitoring unit 113 determines that the host machine 1 on which the TaskTracker container determined in the processing in S32 to exist runs has stopped as illustrated in FIG. 17 (S51). The host machine monitoring unit 113 transmits to the client terminal 5 information indicating that communication response from the TaskTracker container determined in the processing in S32 to exist will not be restarted (S52).

For example, in a case where it is determined in the processing in S41 that no response from the DN 33b exists, the master node 21 determines that an anomaly has occurred in the host machine 13 and blacklists the TT 33a from which it is determined in the processing in S32 that any response is sent. In this case, the master node 21 transmits to the client terminal 5, for example, information indicating that the TT 33a is blacklisted. Afterwards, for example, a provider who has checked the information transmitted to the client terminal 5 starts a TaskTracker container instead of the blacklisted TT 33a on another host machine 1.

In such a manner, the master node 21 is able to redistribute task data targeted for processing among multiple TaskTracker containers including the new TaskTracker container.

Referring back to FIG. 17, in a case where the new TaskTracker container has been started on the other host machine 1 (YES in S53), the data distribution unit 115 redistributes the task data targeted for processing among the multiple TaskTracker containers including the new TaskTracker container (S54).

In a case where a time-out has occurred in the TaskTracker container that is determined to exist in the processing in S32 (YES in S43), the master node 21 also performs the processing from S52 to S54.

As described above, the master node 21 according to the embodiment monitors communication response condition of, for example, the containers 32a and 33a that constitute the multiple slave nodes 22 and 23. When an anomaly is detected in the communication response condition of the given container included in the multiple slave nodes 22 and 23, in accordance with the corresponding information indicating the given host machine on which the given previously deployed container is running, the master node 21 estimates the operating condition of the given host machine.

Subsequently, in accordance with the estimation result, the master node 21 sets a time-out time that is calculated based on the amount of data for distributed processing and that is referred to when it is determined whether to cause the given container to run on a host machine 1 different from the given host machine.

For example, when the master node 21 detects that communication response from the TT 33a is interrupted, referring to the corresponding information, the master node 21 determines whether the host machine 13 on which the TT 33a is running is stopped. Specifically, the master node 21 determines whether an anomaly has occurred in both the containers 3 (the TT 33a and the DN 33b) that are running on the host machine 13 and the host machine 13 or only in the containers 3 that are running on the host machine 13.

Subsequently, for example, when the master node 21 determines that an anomaly has occurred only in the containers 3 running on the host machine 13, the master node 21 uses a time calculated in advance in accordance with the amount of task data targeted for processing as the time-out time that is referred to when it is determined whether a time-out has occurred.

As a result, when the master node 21 determines that no anomaly exists in the host machine 13, it is possible to complete restarting the TT 33a before the time-out time has elapsed. The master node 21 is thus able to avoid the forced interruption of redistributing task data due to restarting the TT 33a after a preset short time-out time. Therefore, the master node 21 is able to efficiently restart the TT 33a and reduce the time for restarting the TT 33a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
monitoring a communication response condition of containers constituting multiple slave nodes included in an information processing system in which a container constituting a master node and the containers constituting the multiple slave nodes cooperate with one another and perform distributed processing;
when an anomaly is detected in the communication response condition of a given container of the containers included in the multiple slave nodes, in accordance with information indicating a given host machine on which the given container is running, estimating an operating condition of the given host machine; and
in accordance with a result of the estimating, setting a time-out time that is calculated based on an amount of data for the distributed processing and that is referred to when it is determined whether to cause the given container to run on a host machine different from the given host machine.

2. The non-transitory, computer-readable recording medium according to claim 1, wherein
the estimating includes determining that the given host machine is in a state in which the given container is not able to run on the given host machine when no response is sent from any one of containers constituting slave nodes of the multiple slave nodes that run on the given host machine.

3. The non-transitory, computer-readable recording medium according to claim 2, wherein
the setting includes setting the time-out time when it is determined that the given host machine is in the state in which the given container is not able to run on the given host machine.

4. The non-transitory, computer-readable recording medium according to claim 1, wherein
the time-out time is calculated by multiplying a value obtained by dividing an amount of the data for the distributed processing by an amount of unit data that is a unit of data for which one slave node of the multiple slave nodes performs processing, a number of copies of the unit data, and a time for allocating the unit data to each of the multiple slave nodes.

5. The non-transitory, computer-readable recording medium according to claim 1, wherein:
redistribution of the data for the distributed processing among the multiple slave nodes is performed at both a first timing of restarting the given container and a second timing when the time-out time has elapsed after a communication response from the given container was interrupted; and
when the second timing occurs during the redistribution of the data for the distributed processing at the first timing, the redistribution of the data for the distributed processing at the first timing is stopped and the redistribution of the data for the distributed processing at the second timing is started.

6. A control apparatus serving as each of multiple slave nodes, the control apparatus comprising:
a memory; and
a processor coupled to the memory and configured to:
monitor a communication response condition of containers constituting the multiple slave nodes included in an information processing system in which a container constituting a master node and the containers constituting the multiple slave nodes cooperate with one another and perform distributed processing,
when an anomaly is detected in the communication response condition of a given container of the containers included in the multiple slave nodes, in accordance with information indicating a given host machine on which the given container is running, estimate an operating condition of the given host machine, and
in accordance with a result of the estimating, set a time-out time that is calculated based on an amount of data for the distributed processing and that is referred to when it is determined whether to cause the given container to run on a host machine different from the given host machine.

7. The control apparatus of claim 6, wherein
the processor determines that the given host machine is in a state in which the given container is not able to run on the given host machine when no response is sent from containers constituting slave nodes of the multiple slave nodes that run on the given host machine.

8. The control apparatus of claim 7, wherein
the processor sets the time-out time when it is determined that the given host machine is in the state in which the given container is not able to run on the given host machine.

9. A control method performed by each of multiple slave nodes, the control method comprising:
monitoring a communication response condition of the containers constituting the multiple slave nodes included in an information processing system in which a container constituting a master node and the containers constituting the multiple slave nodes cooperate with one another and perform distributed processing;
when an anomaly is detected in the communication response condition of a given container of the containers included in the multiple slave nodes, in accordance with information indicating a given host machine on which the given container is running, estimating an operating condition of the given host machine; and
in accordance with a result of the estimating, setting a time-out time that is calculated based on an amount of data for the distributed processing and that is referred to when it is determined whether to cause the given container to run on a host machine different from the given host machine.

10. The control method of claim 9,
wherein the estimating includes determining that the given host machine is in a state in which the given container is not able to run on the given host machine when no response is sent from containers constituting slave nodes of the multiple slave nodes that run on the given host machine.

11. The control method of claim 10,
wherein the setting includes setting the time-out time when it is determined that the given host machine is in the state in which the given container is not able to run on the given host machine.

12. A control method comprising:
monitoring a communication response condition of containers constituting multiple slave nodes of an information processing system;
detecting an anomaly in the communication response condition of a container in accordance with information indicating a first host machine on which the container is operating;
estimating an operating condition of the host machine;
determining whether to cause the container to operate on a second host machine; and
setting a time-out time.

13. The control method of claim 12, wherein the time-out time is calculated based on an amount of data for distributed processing.

14. The control method of claim 12, further comprising determining that the first host machine is in a state in which the container is unable to operate on the first host machine.
